(19) United States
(12) Patent Application Publication
(10) Pub. No.: US 2017/0290734 A1
(43) Pub. Date: Oct. 12, 2017

(54) MASSAGE DEVICE AND METHOD

(71) Applicant: Donald J. McCrea, Bruderheim (CA)

(72) Inventor: Donald J. McCrea, Bruderheim (CA)

(21) Appl. No.: 15/379,752

(22) Filed: Dec. 15, 2016

Related U.S. Application Data
(60) Provisional application No. 62/319,458, filed on Apr. 7, 2016.

(51) Int. Cl. A61H 15/00

(52) U.S. Cl. CPC A61H 15/0092; A61H 2015/005

(57) ABSTRACT

A massage device includes a plurality of massage rollers including a first-end massage roller, a second-end massage roller, and at least one intermediate massage roller, each massage roller having a spherical shape and being rotatable about a roller axis. Further, the device may be constructed of a coated sponge material for a smooth finish to resist sweat or dirt. The massage balls may have bump and pits to facilitate muscle and tissue stimulation. The massage device is useful in the administration of deep-tissue massage. The device may be used to massage many different minor muscle groups located in the hands and feet, as well a major muscle groups in the upper and lower back, and legs.

### CROSS-REFERENCE TO RELATED APPLICATION

The present application is related to and claims priority to U.S. Provisional Patent Application No. 62/319,458 filed Apr. 7, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present disclosure relates generally to the field of kinesitherapy and more specifically relates to massage tools.

### 2. Description of Related Art

Numerous health benefits associated with massage are well known. Massaging of muscles, tendons, and ligaments is known to be beneficial in the management of pain and soreness associated with injuries to soft tissues. Moreover, manual massage is beneficial in treating muscle tightness, lack of flexibility, soft tissue adhesions, knots, and scar tissues. The use of manual massage has also been shown to reduce feelings of anxiety and stress. A need exists for new systems to assist in the administration and self-administration of massage treatments, such as systems including devices and methods that are more convenient, reliable, and inexpensive than those currently in use.

Several attempts have been made to address the above-mentioned need, such as those found in U.S. Patent Application 2008/0103421 to Nicholson, which relates to a massage implement. The described massage implement includes a massage implement including a central axle, at least one handle coupled to the central axle, and a plurality of rollers. The rollers are rotatably mounted to the central axle and can engage the area a user wishes to massage. A user can apply pressure to the at least one handle and move the rollers over the area to be massaged. This art is representative of rolling massage devices, however, the apparatus of Nicholson utilizes a set of opposing end-mounted handles that prevent the full use of the end rollers for massage treatment. Moreover, none of the known prior art, taken either singly or in combination, is seen to describe the system as claimed.

### BRIEF SUMMARY OF THE INVENTION

In view of the foregoing disadvantages inherent in the known art of massage tools, the present disclosure provides a novel massage device and method. The general purpose of the present disclosure, which will be described subsequently in greater detail, is to provide a massage device and method.

According to one embodiment, this disclosure provides a massage device having a plurality of massage rollers including a first-end massage roller, a second-end massage roller, and at least one intermediate massage roller. Each massage roller has a spherical shape and is rotatable about a roller axis. The device includes an elongated member having a first end and a second end, the elongated member coinciding with the roller axis and intersects each of the plurality of massage rollers such that the elongated member passes through the intermediate massage roller, the first end terminates within the first-end massage roller, and the second end terminates within the second-end massage roller. Moreover, the elongated member is configured as an axle such that the at least one intermediate massage roller is rotationally bound to the elongated member to provide concurrent rotation therebetween, the first-end massage roller is rotatably secured to the elongated member, the second-end massage roller is rotatably secured to the elongated member, and a radial force applied to any of the plurality of massage rollers will be transferred to the elongated member.

According to another embodiment, a massage device method is disclosed herein. The method includes the steps of providing an elongated member having a first end and a second end, providing a plurality of massage rollers, coupling the massage rollers to the elongated member, wherein at least one massage roller is rotatable independently of the other massage rollers, and wherein the first end and the second end are each disposed within a respective massage roller of the plurality.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and methods of use for the present disclosure, a massage device and method, constructed and operative according to the teachings of the present disclosure.

FIG. 1 is a perspective view of the massage device during an ‘in-use’ condition, according to an embodiment of the disclosure.

FIG. 2 is a perspective view of the massage device of FIG. 1, according to an embodiment of the present disclosure.

FIG. 3 is a perspective view of an internal support structure of the massage device of FIG. 1, according to an embodiment of the present disclosure.

FIG. 4 is an exploded perspective view of the internal support structure of the massage device of FIG. 1, according to an embodiment of the present disclosure.

FIG. 5 is sectional view through the section 5-5 of FIG. 2, according to an embodiment of the present disclosure.

FIG. 6 is a flow diagram illustrating a method of use for the massage device, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to a body or bodies disposed on a single axis and more particularly to a massage device and method as used to improve the administration of both shallow and deep-tissue massage.

Generally, disclosed is a deep tissue massager that incorporates three independently rotating massage rollers (balls) to allow a user to administer self-therapy. The device may be used to massage many different minor muscle groups located in the hands and feet, as well a major muscle groups in the upper and lower back, and legs. The device may be placed on the floor when massaging the hands and feet. While holding the device in the hands, a user can massage the back and legs comfortably. The massage balls may have bumps and pits to facilitate muscle and tissue stimulation. Furthermore, the device may be constructed of a sponge-like material having an outer coating for a smooth finish to resist sweat or dirt.

The two end balls have the ability to rotate independently. The middle ball is fastened to an elongated central shaft. Holding the end balls, a user may roll the middle ball on outside thighs and legs. Traversing the upper body with the device may provide release of pressure points, taught bands, and reductions in myofascial pain. Using the device may help improve attention span. The device stimulates muscles and may stimulate neurons in the brain to decease aging process.

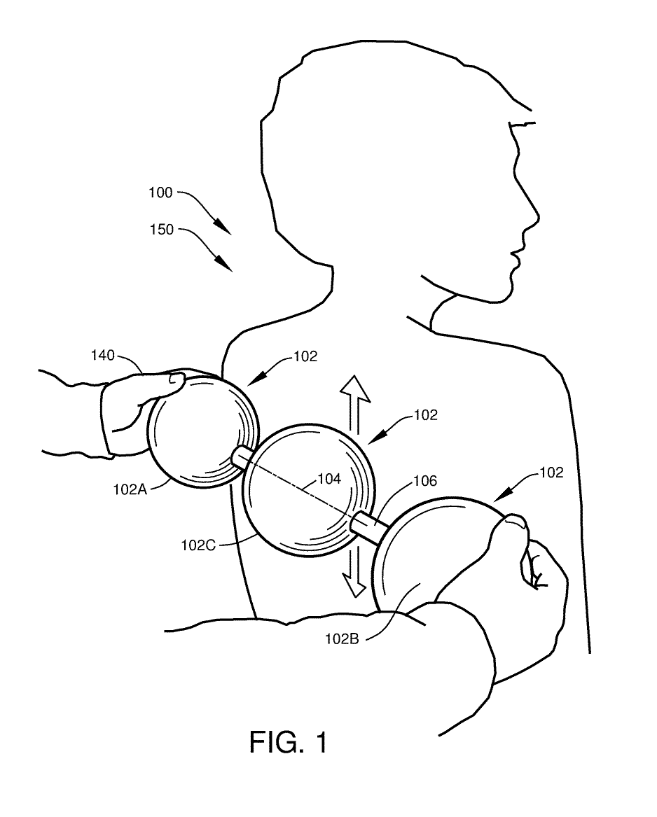

Referring now more specifically to the drawings by numerals of reference, there is shown in FIGS. 1-5, various views of a massage device 100. FIG. 1 shows the massage device 100 during an ‘in-use’ condition 150, according to an embodiment of the present disclosure. Here, the massage device 100 may be beneficial for use by a user 140 to assist in administering manual massage. As illustrated, the massage device 100 may include a plurality of massage rollers 102 including a first-end massage roller 102A, a second-end massage roller 102B, and at least one intermediate massage roller 102C, as shown. Each massage roller 102 has a generally spherical shape and is rotatable about a roller axis 104.

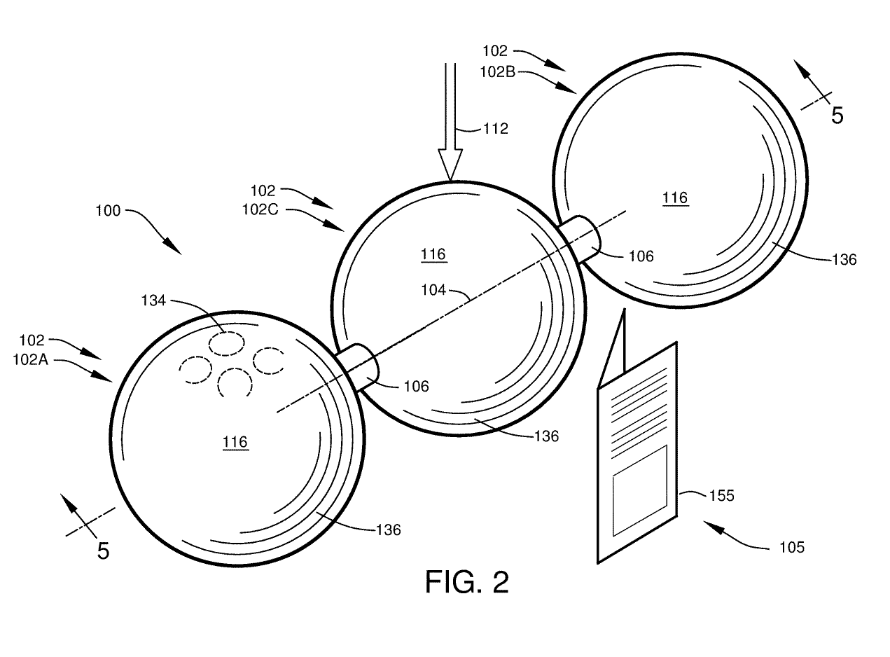

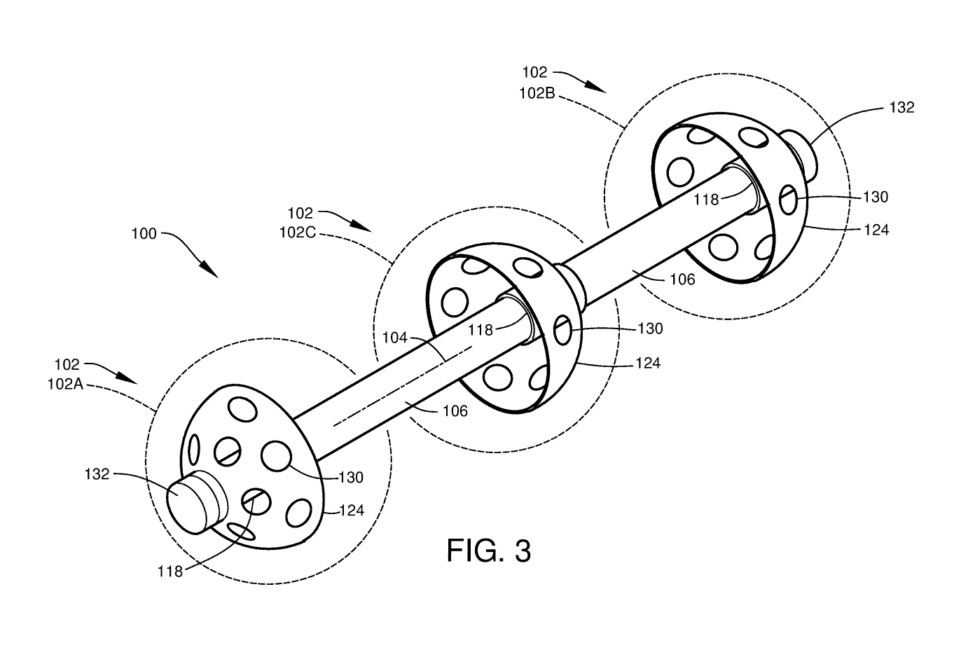

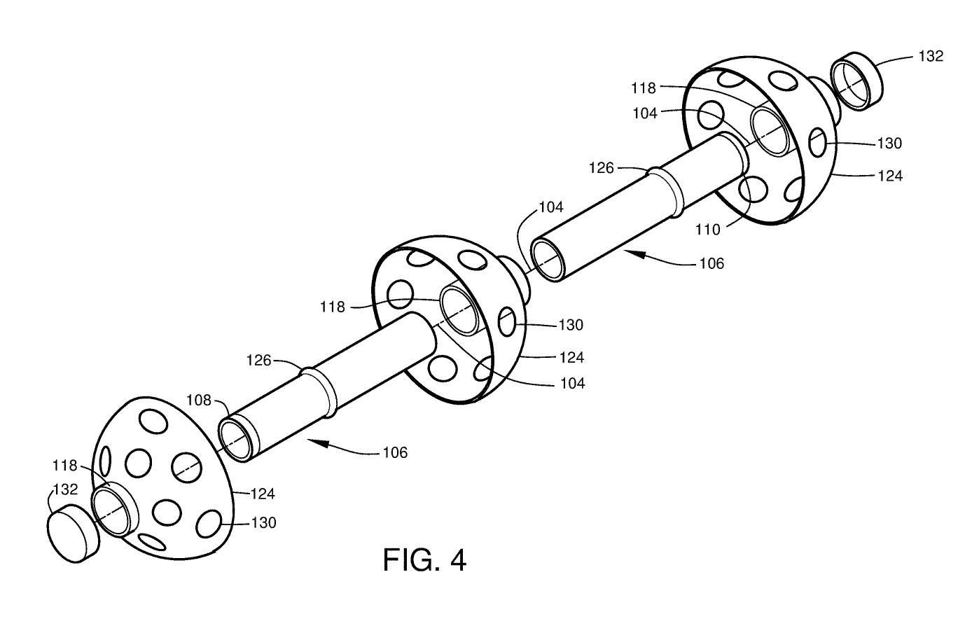

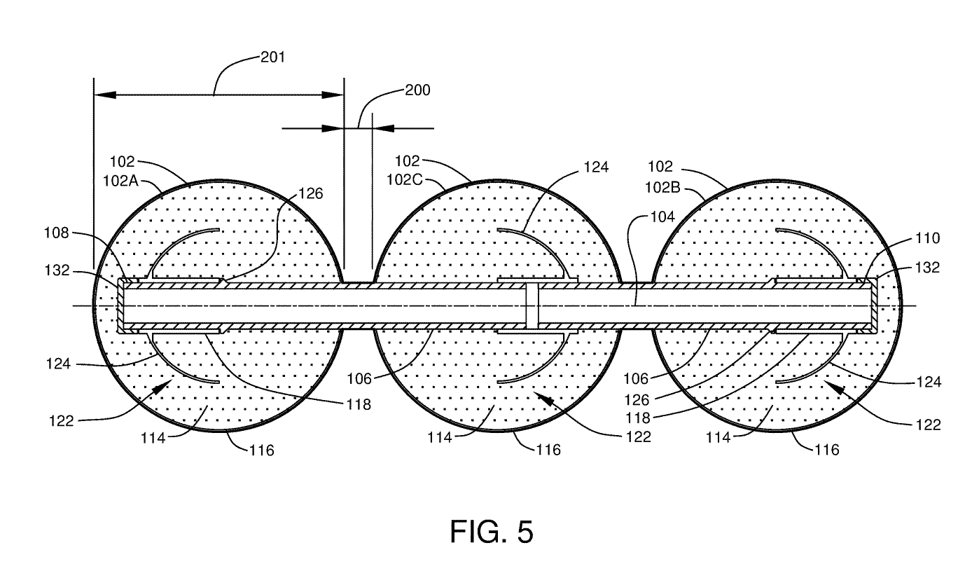

Referring to the drawings together, FIG. 2 is a perspective view of the massage device of FIG. 1. FIG. 3 and FIG. 4 are perspective views of an internal support structure 122 of the massage device of FIG. 1. Note that the foam portions of the massage device 100 have been omitted from the views of FIG. 3 and FIG. 4 for clarity of description. FIG. 5 is sectional view through the section 5-5 of FIG. 2, according to an embodiment of the present disclosure.

As best illustrated in FIG. 5, the massage device 100 includes an elongated member 106 that both coincides with the roller axis 104 and intersects each of the plurality of massage rollers 102. The assembly is arranged such that a radial force 112 applied to any of the plurality of massage rollers 102 is transferred to the elongated member 106, as illustrated in FIG. 2.

The elongated member 106 includes a first end 108, a second end 110, and an intermediate segment therebetween that passes through the intermediate massage roller 102C, as shown. It is important to note that the first end 108 of the elongated member 106 terminates within the first-end massage roller 102A, and the second end 110 terminates within the second-end massage roller 102B. This allows essentially the entire outer surface of the first-end massage roller 102A and the second-end massage roller 102B to remain available for contact with the body.

In one embodiment of present system, the elongated member 106 is a rigid cylindrical bar configured as an axle about which the massage rollers 102 may rotate. The intermediate massage roller 102C is rotationally bound to the elongated member 106 to provide concurrent rotation between the elongated member 106 and the intermediate (middle) roller. The first-end massage roller 102A and the second-end massage roller 102B are both rotatably secured to the elongated member 106.

In one embodiment of the present disclosure, the plurality of massage rollers 102 include three massage rollers 102. In addition, the plurality of massage rollers 102 are disposed on the elongated member 106 in a spaced-apart relationship, and the space 200 between the massage rollers 102 may be between about ½ inch and about ¾ inch. In the depicted embodiment, the size of each of the massage rollers 102 may be substantially similar to each other.

In one embodiment of the present system, the largest cross-sectional dimension 201 of each massage roller 102 may be about four inches. Upon reading this specification, it should be appreciated that, under appropriate circumstances, considering such issues as user preferences, design preference, structural requirements, marketing preferences, cost, available materials, etc., other massage roller arrangements such as, for example, larger or smaller rollers, rollers of differing size or shape, etc., may be sufficient.

In one embodiment of the present disclosure, the massage rollers 102 are made from a resilient material such as resilient foam 114. In one embodiment of the present disclosure, the resilient foam is polyurethane. Upon reading this specification, it should be appreciated that, under appropriate circumstances, considering such issues as intended use, design preference, structural requirements, cost, available materials, etc., other material arrangements such as, for example, the use of alternate polymers, combining several polymers to form a mixture or composite, etc., may be sufficient. The resilient foam 114 may be covered with a non-absorbent moisture-resistant coating 116 to promote durability and assist cleaning.

Referring to FIG. 2, in one embodiment of the present system, the outer surface of the massage rollers may include a smooth finish, as shown. In another embodiment of the present system, the outer surface 136 of the massage rollers 102 may include a plurality of raised projections 134. A preferred color may be provided to the outer surface 136 by coating, mixing or blending the material forming the outer surface 136 with a pigment and/or dye, or by other well-known methods. Upon reading this specification, it should be appreciated that, under appropriate circumstances, considering such issues as user preferences, design preference, marketing preferences, cost, available materials, available printing techniques, etc., the use of other visual elements such as, for example, differing surface textures, printed text, photographic depictions, symbols, character depictions, corporate branding, team logos, etc., may be sufficient.

According to one embodiment, the massage device 100 may be arranged as a kit 105. In particular, the massage device 100 may further include a set of instructions 155. The instructions 155 may detail functional relationships in relation to the structure of the massage device 100 (such that the massage device 100 can be used, maintained, or the like, in a preferred manner).

Returning to FIG. 5, embodiments of the present disclosure includes friction-reducing sleeve bearings 118, as shown. The first-end massage roller 102A and the second-end massage roller 102B may each include a friction-reducing sleeve bearing 118 surrounding a respective end portion 108, 110 of the elongated member 106. Each sleeve bearing 118 may be rotatable about the elongated member 106 and the roller axis 104. A non-toxic grease may be provided between the elongated member 106 and bearings 118 during assembly to further reduce friction within the system.

In addition, each massage roller 102 may include an inner support structure 122 imbedded within the resilient foam 114. Each inner support structure 122 may include a hemispherical shell 124 having a plurality of spaced-apart perforations 130 (FIG. 4) extending through the shell wall, as shown. The material forming the hemispherical shell 124 has a rigidity or hardness greater than that of the resilient foam 114. In one embodiment of the present disclosure, the hemispherical shell 124 may be constructed from a semi-rigid plastic. In one embodiment of the present system, the hemispherical shells 124 may have a diameter that is about one inch smaller than that of the foam balls.

The hemispherical shell 124 of the first-end massage roller 102A may be coupled to the sleeve bearing 118 of the first-end massage roller 102A, as shown. Similarly, the hemispherical shell 124 of the second-end massage roller 102B may be coupled to the sleeve bearing 118 of the second-end massage roller 102B. The sleeve bearings 118 are sized larger than the outer shaft of the elongated member 106, allowing rotation.

The inner support structure 122 of the intermediate massage roller 102C is rigidly coupled to the elongated member 106. In one embodiment of the present disclosure, the elongated member 106 is divided into two segments joined at the inner support structure 122 of the intermediate massage roller 102C. The elongated member 106 may include a set of positional retainers 126 used to position and retain the sleeve bearings 118 on the elongated member 106. The inner positional retainers 126 are a set of enlarged circumferential stops, which prevents the end support structure 122 from moving inward.

A set of end caps 132 retain the end support structures 122 on the elongated member 106 by preventing the end support structures 122 from moving outward. The end caps 132 may be retained on the elongated member 106 by a snap-fit engagement or by a retaining pin. Each end cap 132 may extend to within about one inch of the outer coating 116. This makes the device easier to hold when moving the product over the body and allows essentially the entire outer surface of the end massage rollers 102 to be used for massage manipulation. During use, a hand (manual) force may be applied to the massage rollers 102 compressing the foam. The support structures 122 provide a progressive resistance to the compression, thus allowing the massage pressure to transition from soft to relatively firm in a controlled manner Application of a strong massage pressure will have the effect of bending the semi-rigid plastic of the shells along with the foam. This unique feature may add considerable versatility to the pressure delivered by the massage device 100.

One technique that may be used to fabricate the disclosed device utilizes a co-molding or over-molding procedure. More specifically, a set of two-part ball molds are placed over the fully or partially assembled inner support structures, sleeve bearings, and couplings. Mold release is applied to the elongated member and ball molds. The ball molds are centered and align properly relative to the supports and the molds are filled with expanding polyurethane foam. The foam expands within the molds and adheres to the holes in the hemispherical shells. Upon reading this specification, it should be appreciated that, under appropriate circumstances, considering such issues as user preferences, design preference, structural requirements, marketing preferences, cost, available materials, technological advances, etc., other fabrication arrangements such as, for example, injection molding, casting, dipping, spraying, molding the individual part separately, etc., may be sufficient.

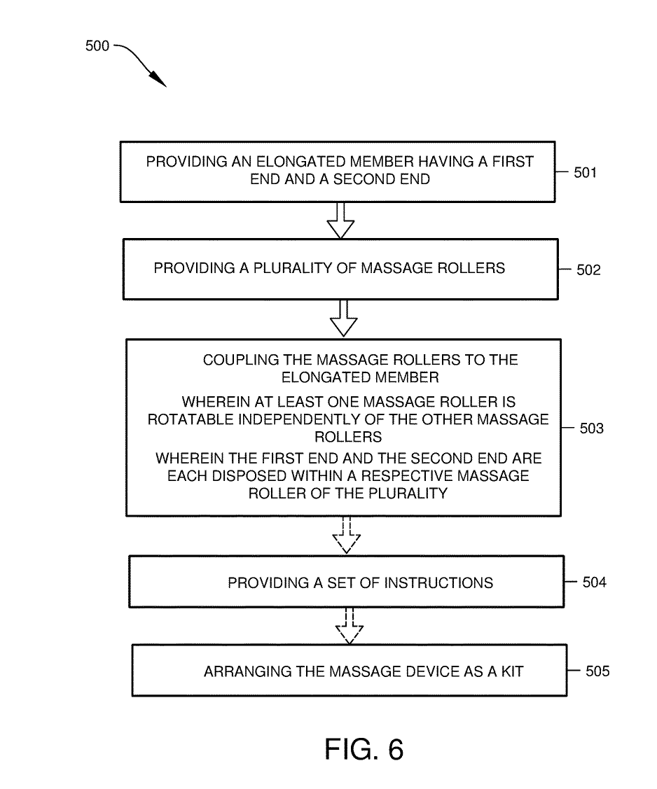

FIG. 6 is a flow diagram illustrating a method for providing a massage device, according to an embodiment of the present disclosure. In particular, the method for providing a massage device 500 may include one or more components or features of the massage device 100 as described above. As illustrated, the method 500 may include the steps of: step one 501, providing an elongated member having a first end and a second end, step two 502, providing a plurality of massage rollers, step three 503, coupling the massage rollers to the elongated member, wherein at least one massage roller is rotatable independently of the other massage rollers, and wherein the first end and the second end are each disposed within a respective massage roller of the plurality.

In addition, the method 500 may further include the steps of: step four 504, providing a set of instructions, and step five 505, arranging the massage device as a kit. It should be noted that step four 504 and step five 505 are an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for providing a massage device (e.g., different step orders within above-mentioned list, elimination or addition of certain steps, including or excluding certain maintenance steps, etc.), are taught herein.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A massage device comprising:
a plurality of massage rollers including a first-end massage roller, a second-end massage roller, and at least one intermediate massage roller, each massage roller having a spherical shape and being rotatable about a roller axis;
an elongated member having a first end and a second end, the elongated member coinciding with the roller axis and intersecting each of the plurality of massage rollers such that
the elongated member passes through the at least one intermediate massage roller,
the first end terminates within the first-end massage roller, and
the second end terminates within the second-end massage roller,
the elongated member fixed to the at least one intermediate massage roller and configured as an axle such that concurrent rotation is provided therebetween,
the elongated member rotatably secured to the first-end massage roller and the second-end massage roller, respectively, and
the elongated member configured such that a radial force applied to any of the plurality of massage rollers will be transferred to the elongated member.

2. The massage device of claim 1, wherein the plurality of massage rollers consists of three massage rollers.

3. The massage device of claim 1, wherein the plurality of massage rollers are disposed on the elongated member in a spaced-apart relationship, and a space between each of the plurality of the massage rollers is between approximately ½ inch and approximately ¾ inch.

4. The massage device of claim 1, wherein each of the plurality of the massage rollers are substantially similar in size.

5. The massage device of claim 1, wherein a largest cross-sectional dimension of each of the plurality of massage rollers is approximately four inches.

6. The massage device of claim 1, wherein each of the plurality of the massage rollers includes a resilient material.

7. The massage device of claim 1, wherein each of the plurality of the massage rollers includes a resilient foam.

8. The massage device of claim 7, wherein the resilient foam includes a non-absorbent moisture-resistant coating.

9. The massage device of claim 7, wherein the resilient foam includes polyurethane.

10. The massage device of claim 7, wherein the first-end massage roller and the second-end massage roller each includes a sleeve bearing surrounding a respective end portion of the elongated member, the sleeve bearings being rotatable about the elongated member and the roller axis.

11. The massage device of claim 10, wherein each of the plurality of massage rollers includes an inner support imbedded within the resilient foam, each inner support including a hemispherical shell having a plurality of spaced-apart perforations extending therethrough, the material forming the hemispherical shell having a hardness greater than that of the resilient foam.

12. The massage device of claim 10, wherein the hemispherical shell is made of a semi-rigid plastic.

13. The massage device of claim 10, wherein the inner support structure of the first-end massage roller is coupled to the sleeve bearing of the first-end massage roller, the inner support structure of the second-end massage roller is coupled to the sleeve bearing of the second-end massage roller, and the inner support structure of the at least one intermediate massage roller is coupled to the elongated member.

14. The massage device of claim 1, wherein each outer surface of the plurality of massage rollers includes a smooth finish.

15. The massage device of claim 1, wherein the outer surface of each of the plurality of the massage rollers includes a plurality of raised projections.

16. The massage device of claim 1, wherein the elongated member includes a rigid cylindrical bar.

17. A massage device comprising:
a plurality of massage rollers including a first-end massage roller, a second-end massage roller, and at least one intermediate massage roller, each massage roller having a spherical shape and being rotatable about a roller axis;
an elongated member having a first end and a second end, the elongated member coinciding with the roller axis and intersecting each of the plurality of massage rollers such that
the elongated member passes through the at least one intermediate massage roller,
the first end terminates within the first-end massage roller, and
the second end terminates within the second-end massage roller,
the elongated member fixed to the at least one intermediate massage roller and configured as an axle such that concurrent rotation is provided therebetween,
the elongated member rotatably secured to the first-end massage roller and the second-end massage roller, respectively, and
the elongated member configured such that a radial force applied to any of the plurality of massage rollers will be transferred to the elongated member;
wherein the plurality of massage rollers consists of three massage rollers;
wherein the plurality of massage rollers are disposed on the elongated member in a spaced-apart relationship,; and a space between each of the plurality of the massage rollers is between approximately ½ inch and approximately ¾ inch;
wherein each of the plurality of the massage rollers are substantially similar in size;
wherein a largest cross-sectional dimension of each of the plurality of massage rollers is approximately four inches;
wherein each of the plurality of the massage rollers includes a resilient material;
wherein each of the plurality of the massage rollers includes a resilient foam;
wherein each of the plurality of the resilient foam includes a non-absorbent moisture-resistant coating;
wherein the resilient foam includes polyurethane;
wherein the first-end massage roller and the second-end massage roller each includes a sleeve bearing surrounding a respective end portion of the elongated member, the sleeve bearings being rotatable about the elongated member and the roller axis;
wherein each of the plurality of massage rollers includes an inner support imbedded within the resilient foam, each inner support including a hemispherical shell having a plurality of spaced-apart perforations extending therethrough, the material forming the hemispherical shell having a hardness greater than that of the resilient foam;
wherein the hemispherical shell is made of a semi-rigid plastic;
wherein the inner support structure of the first-end massage roller is coupled to the sleeve bearing of the first-end massage roller, the inner support structure of the second-end massage roller is coupled to the sleeve bearing of the second-end massage roller, and the inner support structure of the at least one intermediate massage roller is coupled to the elongated member;
wherein the elongated member includes a rigid cylindrical bar; and
wherein the elongated member includes positional retainers configured to position and retain sleeve bearings on the elongated member.

18. The massage device of claim 17, further comprising set of instructions; and
wherein the massage device is arranged as a kit.

19. A massage device method comprising the steps of:
providing an elongated member having a first end and a second end;
providing a plurality of massage rollers;
coupling the plurality of massage rollers to the elongated member;
wherein at least one of the plurality of massage rollers is rotatable independently of the others of the plurality of massage rollers; and
wherein the first end and the second end are each disposed within a respective massage roller of the plurality of massage rollers.

20. The method of claim 19, further comprising the steps of:
providing a set of instructions; and
arranging the massage device as a kit.
